(19) United States
(12) Patent Application Publication
(10) Pub. No.: US 2008/0075811 A1
(43) Pub. Date: Mar. 27, 2008

(54) COATED PARTICLES AND THEIR USE

(76) Inventors: Peter Horlacher, Bellenberg (DE); Andreas Sander, Illertlssen (DE)

Correspondence Address: COGNIS CORPORATION;PATENT DEPARTMENT, 300 BROOKSIDE AVENUE, AMBLER, PA, 19002, US

(21) Appl. No.: 11/858,367

(22) Filed: Sep. 20, 2007

(30) Foreign Application Priority Data
Sep. 23, 2006 (EP) 06019946

(51) Int. Cl. A23D 7/00; A23D 9/00; A23L 1/31

(52) U.S. Cl. 426/92; 426/438; 426/580; 426/609; 426/98

(57) ABSTRACT

The invention relates to particles with a coreshell structure, the core containing an oil or fat and the shell containing a second fat. The invention also relates to the use of the particles according to the invention for the production of foods and to a process for the production of a food comprising contacting the particles according to the invention with other constituents of the food and to a food containing the particles according to the invention.

### CROSS-REFERENCE TO RELATED APPLICATIONS

This application claims priority from EP 06019946.0 filed September 23, 2006; the entire contents of which is incorporated herein for reference.

### FIELD OF THE INVENTION

This invention relates to particles with a coreshell structure, the core containing an oil or fat and the shell containing a second fat. The invention also relates to the use of the particles according to the invention for the production of foods and to a process for the production of a food comprising contacting the particles according to the invention with other constituents of the food and to a food containing the particles off the invention.

### BACKGROUND OF THE INVENTION

Margarine containing omega-3 fatty acids is known and available on the market, for example from Unilever which markets its margarine under the name of Becel®. Omega-3 fatty acids are generally present in the margarine as glycerol esters.

It is of advantage for various health benefit reasons to have margarine or even other fat-containing foods available which contain omega3 fatty acids.

Highly refined fish oils, for example, may be used as the source of omega-3 fatty acids. These fish oils generally have to be highly refined (i.e. in particular also deodorized) so as to avoid the otherwise typical secondary taste.

Besides the use of fish oil in margarine, there are many other areas of food technology which require the use of oils or fats that are highly vulnerable to spoiling, for example because they are sensitive to oxidation, as is the case with fish oil for example.

U.S. Pat. No. 6,136,364 discloses an emulsion where oil particles are emulsified in water, this first emulsion in turn forming particles which are emulsified in a continuous oil phase. Particles with a core-shell structure are not disclosed; instead the oil phase includes a number of “cores” which, in turn, are oil-in-water emulsions.

U.S. Pat. No. 4,710,391 discloses solid particles containing paprika flavors, gum arabic and modified starch. These particles are then coated with a fat. Accordingly, the particles according to the document in question do not have a core whose melting point is at least 1° C. lower than the melting point of the shell. Rather, the core is heterogeneous and, if a melting point can be defined at all, has a high melting point (U.S. Pat. No. 4,710,391, column 3, line 6: “hard particles”).

U.S. Pat. No. 3,867,556 discloses particles containing butter oil and hydrogenated palm fat. A core-shell structure is not mentioned.

U.S. Pat. No. 2,828,206, Example 3, discloses a spray-dried multicomponent mixture which forms solid particles. These solid particles are coated with hydrogenated cottonseed oil. The melting point of the coated particles is not disclosed.

JP 09 125 087 discloses particles which consist of a powder coated with fat. The powder, i.e. the core of the particles, contains inter alia modified starch and, accordingly, cannot be melted without decomposition. At all events, the core does not have a lower melting point than the shell of the particles disclosed in JP 09 125 087.

It is desirable to be able to provide sensitive fats or oils in a form in which they are protected against spoiling, for example through oxidation. In addition, the form in which the sensitive fats or oils are supplied should provide for easy subsequent processing in foods. It should be possible to carry out further processing in such a way that the form in which the sensitive fats or oils are supplied remains intact during their further processing. In addition, it should also be possible to carry out further processing in such a way that the form in which the sensitive fats or oils are supplied is destroyed during their further processing and the sensitive fats or oils are released in the process.

### BRIEF DESCRIPTION OF THE INVENTION

The problem stated in the preceding paragraph is solved by the particles according to the invention which are one subject of the present invention.

The present invention relates to particles with a core-shell structure where the core contains an oil or fat, the shell contains a second fat, the melting point of the shell is at least 1° C., more particularly at least 3° C., more particularly at least 5° C., more particularly at least 10° C. and more particularly at least 15° C. higher than the melting point of the core, the core is preferably liquid and the shell is preferably solid.

### BRIEF DESCRIPTION OF THE DRAWINGS

FIG. 1 is a schematic representation of the droplet forming device for forming the particles.

FIG. 2 is a micrograph of particles of the invention.

### DETAILED DESCRIPTION OF THE INVENTION

In one particular embodiment of the particles according to the invention, the core forms a homogeneous phase.

In another particular embodiment of the particles according to the invention, the shell forms a homogeneous phase.

In another particular embodiment of the particles according to the invention, the oil or fat present in the core contains omega-3 fatty acids. The omega-3 fatty acids are generally present in the oil or fat in the form of their esters, more especially their esters with glycerol or their esters with monoacyl glycerol esters or their esters with diacyl glycerol esters. Preferred particles are those in which at least 1% by weight, more particularly at least 2% by weight, more particularly at least 5% by weight and more particularly at least 10% by weight of the core consists of omega-3 fatty acids which may be present in free or bound form, the weight of the omega-3 fatty acids being calculated as free omega-3 fatty acids.

In another particular embodiment of the particles according to the invention, the oil or fat present in the core is fish oil.

In another particular embodiment of the particles according to the invention, the second fat contained in the shell contains only saturated or monounsaturated fatty acids and is selected in particular from the group consisting of hydrogenated palm oil, hydrogenated colza oil and soybean oil. In addition, so-called skeletal fats which are used in the production of margarine may also be used.

In another particular embodiment of the particles according to the invention, the oil or fat contained in the core makes up at least 10% by weight, more particularly at least 30% by weight and more particularly 30 to 70% by weight of the particle weight.

In another particular embodiment of the particles according to the invention, the particles have a mean diameter of 0.05 to 0.5 mm and more particularly of 0.1 to 0.4 mm, the mean diameter being determined by evaluation of micrographs.

The present invention also relates to the use of the particles according to the invention for the production of foods, more particularly for the production of margarine.

The present invention also relates to a process for the production of a food comprising contacting the particles according to the invention with other constituents of the food, the process further comprising in particular the destruction of the particles (more particularly by melting).

The present invention also relates to a food containing the particles according to the invention.

The present invention also relates to the food according to the invention, the food being selected from the group consisting of a milk product, more especially yogurt, a snack bar, a sausage-based product, a meat-based product and bread.

The particles according to the invention have many advantages. The particles according to the invention protect the coated oil or fat, for example against oxidation during storage, transportation and processing. In addition, the particles according to the invention reduce an unpleasant odor or taste possibly present in the coated oil or fat.

For example, the particles according to the invention may be used as a constituent of foods, in which case they may contain fish oil or similar naturally odor- or taste-intensive oils or fats. Unpleasant sensory properties (odor, taste) are avoided by the particles without the fish oil (or the other oils or fats used) having to be highly refined in the usual way. In spite of this, the valuable omega-3 fatty acids of the fish oil, for example, can still be introduced into the fat-containing food.

In addition, margarine, for example, can be produced from the particles according to the invention, in which case the particles may contain, for example, fish oil which introduces omega-3 fatty acids into the margarine. The particles may be destroyed by melting during their incorporation in the margarine, so that no unpleasant particles are sensed by the tongue during consumption of the margarine. In this way, the fish oil was protected before incorporation in the margarine. After incorporation, it is protected by the fatty matrix of the margarine.

EP 0 7 26 765 discloses a process for the production of solid forms with controlled release of active ingredient and an apparatus for carrying out this process. The particles according to the present invention can be produced by this process.

In addition, the particles according to the invention can be introduced into foods without destruction providing their granular structure is not problematic.

In addition, relatively low-purity fish oils, for example, can be used in the particles according to the invention because the odor and taste of the fish oil are concealed by the shell of the particles.

The particles according to the invention are generally substantially spherical in shape from their production.

### EXAMPLES

### Example 1

### Production of the Particles

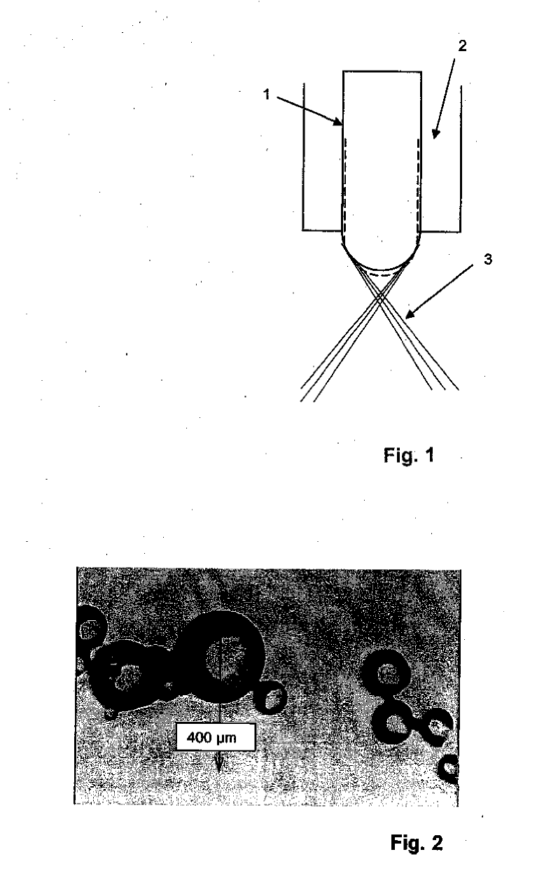

The particles are produced by the process described in EP-B 0 726 765 B1 (the entire contents of which are incorporated herein by reference). FIG. 1 shows the apparatus used. The vibrating spray head (1) was switched on 20-25 (kHz). The product (homogeneous fatty melt as described in the following) was delivered to the product inlet (2). The product emerged tangentially at the product outlet (3). The droplets formed were made to rotate by the vibration on leaving the spray head (1). The sprayjet was directed into a chamber cooled to −20° C. to −50° C.

Fish oil was mixed with hydrogenated palm oil and heated until the two components were completely liquid and homogeneously mixed. The crude product mixture was introduced into the spray head (1) via a heatable holding tank. The spray head (1) consisted essentially of a ram rounded off at its lower end and a ring fitting exactly around the ram into which the product was introduced. Under the effect of the high-frequency vibrations, the ram of the spray head changed shape so that product could emerge through the gap formed in rhythm with the vibrations. The vibrations accelerated the droplets formed and projected them tangentially from the rounded end towards the collecting chamber. At the same time, the droplets were set rotating. The collecting chamber was cooled by liquid nitrogen. Temperatures of −50° C. to −20° C. were normally adjusted.

The technical data of the test procedure were as follows:

| | |
|---|---|
| Nitrogen consumption | 0.5 kg N₂/l product |
| Vibration frequency | 20-25 kHz |

The following tests were carried out:

| | | | Temperature | Temperature | Rape, | |
|---|---|---|---|---|---|---|
| | | | of holding | of collecting | colza oil, | |
| | | Quantity | tank | chamber | hydr. | |
| Test No. | Raw material | [%] | [° C.] | [° C.] | [%] | Remarks |
| 1 | Fish oil | 50 | 75-75 | −40 | 50 | Readily |
| | 18/12 | | | | | sprayable |
| 2 | Fish oil | 60 | 75-75 | −40 | 40 | Readily |
| | 18/12 | | | | | sprayable |
| 3 | Fish oil | 40 | 75-75 | −40 | 60 | Readily |
| | 18/12 | | | | | sprayable |

FIG. 2 shows fish oil particles (40% by weight in hydrogenated palm oil) obtained as described in Example 1 (magnification ×100).

### Example 2

### Incorporation In Margarine

The coated fish oil particles from Example 1 were incorporated in margarine.

### Example 2-1

Coated fish oil particles (60% by weight fish oil, 40% by weight hydrogenated colza oil) were incorporated in margarine at room temperature.

| | | | Margarine |
|---|---|---|---|
| | | Margarine with raw | with raw |
| | Margarine | cream + | cream + |
| | without raw | 10% coated fish | 20% coated |
| Mean values | cream | oil | fish oil |
| Rancid taste | 0.00 | 0.00 | 0.00 |
| “Gritty” taste (i.e. | 0.00 | 1.00 | 2.00 |
| particles can be felt | | | |
| on the tongue) | | | |
| Fishy taste | 0.00 | 0.00 | 0.00 |

The numbers used for the sensory evaluation have the following meanings: 0=neutral, 1=light, 2=medium, 3=strong. This means, for example, that the gritty impression where 10% coated fish oil was added was slight.

As expected, the fish oil capsules were noticeable in the mouth.

### Example 2-2

Coated fish oil capsules (60% by weight fish oil, 40% by weight hydrogenated colza oil) were incorporated in margarine at 60° C.

| | Margarine | Margarine with raw | Margarine with raw |
|---|---|---|---|
| | without raw | cream + 10% coated | cream + 20% coated |
| Mean values | cream | fish oil | fish oil |
| Rancid taste | 0.00 | 0.00 | 0.00 |
| Gritty taste | 0.00 | 0.00 | 0.00 |
| Fishy taste | 0.00 | 0.00 | 0.00 |

Despite the high fish oil content of up to 20%, no fish taste could be identified in either Example. The content of LC-PUFAs (long chain polyunsaturated fatty acids) (omega 3) in these Examples was 1.8 g (10% fish oil capsules) and 3.6 g (20% fish oil capsules), respectively.

1. A particle with a core-shell structure, comprising
(a) a core containing an oil or fat;
(b) a shell containing a second fat, wherein, a melting point of the shell is at least 1° C. higher than the melting point of the core.

2. The particle of claim 1, wherein, the core is a homogeneous phase.

3. The particle of claim 1, wherein, the shell is a homogeneous phase.

4. The particle of claim 1, wherein, the core contains omega-3 fatty acids.

5. The particle of claim 1, wherein, the second fat contained in the shell contains only at least one member selected from the group consisting of saturated and monounsaturated fatty acid residues.

6. The particles of claim 1, wherein, the oil or fat contained in the core comprises at least 10% of the particle weight.

7. The particles of claim 1, wherein, the particles have a mean diameter of 0.05 to 0.5 mm, the mean diameter being determined by evaluation of micrographs.

8. Margarine containing the particles of claim 1.

9. A process for the production of a food comprising contacting the particles of claim 1 with other constituents of the food.

10. A food selected from the group consisting of milk products, snack bars, sausage-based products, meat-based products and bread containing particles of claim 1.

11. The particle of claim 4, wherein, the core contains fish oil.

12. The particles of claim 7, wherein, the mean diameter of the particles is in a range of 0.1 to 0.4 mm.

13. The particles of claim 1, wherein, the melting point of the shell is at least 5° C. higher than the melting point of the core.

14. The particles of claim 13, wherein, the melting point of the shell is at least 1 0° C. higher than the melting point of the core.

15. The particles of claim 14, wherein, the melting point of the shell is at least 15° C. higher than the melting point of the core.
